(19) United States
(12) Patent Application Publication
(10) Pub. No.: US 2015/0360629 A1
(43) Pub. Date: Dec. 17, 2015

(54) REINFORCEMENT STRUCTURE FOR POWER-SUPPLYING CASE

(71) Applicant: YAZAKI CORPORATION, Minato-ku, Tokyo (JP)

(72) Inventors: Tsukasa Sekino, Makinohara-shi (JP); Sinji Kato, Makinohara-shi (JP)

(21) Appl. No.: 14/762,238

(22) PCT Filed: Feb. 4, 2014
(86) PCT No.: PCT/JP2014/052489

§ 371 Date: Jul. 21, 2015

(30) Foreign Application Priority Data
Feb. 5, 2013 (JP) 2013-020095

(51) Int. Cl. B60R 16/02; H02G 3/04; B60R 16/037

(52) U.S. Cl. CPC B60R 16/0215; B60R 16/037; H02G 3/0468; H02G 3/0487

(57) ABSTRACT

The present invention is provided with a wire harness having an exterior member; and a case that accommodates the wire harness, wherein the exterior member has rigidity portions disposed between wall portions of the case in a direction orthogonal to the wall portions, the wall portions being opposite to each other, and when external force acts on the wall portions, the rigidity portions are arranged in directions in which the external force acts on the wall portions to support the wall portions together with the exterior member. The exterior member is a corrugated tube, and the rigidity portions are reinforcing ribs formed on its sidewalls. Alternately, the exterior member is a caterpillar-like member and the rigidity portions are its sidewalls.

### TECHNICAL FIELD

The present invention relates to a reinforcement structure for a power-supplying case coping with external force such as foot treading over the power-supplying case in a state where a wire harness is accommodated in the power-supplying case mounted on a floor of a vehicle, for example.

### BACKGROUND ART

Conventionally, for example, various power supply devices have been proposed to constantly supply power to electric components or auxiliary machines of a sliding seat for the vehicle.

For example, Patent Literature 1 (not illustrated) discloses a power supply device configured in such a manner that: a wire harness is arranged in a horizontally-long flat metal case while being bent into a substantially U-shape or J-shape; a slider is slidably engaged with a rail in the case; one end side of the wire harness is led to a sliding seat side while being fixed to the slider; and the other end of the wire harness is led to a vehicle floor side (power source side) from the case. The wire harness in the case is covered with a bellows-like corrugated tube made of a synthetic resin.

Patent Literature 2 (not illustrated) discloses a power supply device configured in such a manner that: a first horizontally-long metal case and a second horizontally-longer metal case are connected to each other in parallel at one end; one part of a wire harness is arranged in the second case in a straight manner (in a row) and is led to a sliding seat side while being fixed to a slider along the second case; and the other part of the wire harness is arranged in two rows in the first case while being folded into a substantially U-shape and the folded portion is led to a vehicle floor side (power source side) from one end side of the case. The wire harness in each of the cases is covered with a corrugated tube made of a synthetic resin.

Patent Literature 3 (not illustrated) does not disclose a power supply device, but discloses a bellows-like metal pipe as an impact energy absorbing material which is disposed inside a door of a vehicle, for example. The shape of the pipe is set to be a triangle, a square, or a pentagon in cross section.

Patent Literature 4 (not illustrated) discloses a corrugated tube as a harness protecting tube for supplying power, the corrugated tube being made of a synthetic resin and having a quadrangle cross section.

Patent Literature 5 (not illustrated) discloses a harness protecting tool for supplying power in which plurality of piece members covering three sides of a wire harness with a substrate and side plates formed on both sides of the substrate are bendably connected to each other by a thin hinge.

### CITATION LIST

### Patent Literature

### Patent Literature 1: JP 2006-35961 A (FIGS. 1 to 3)

### Patent Literature 2: WO 2010/095483 A (FIGS. 9 and 10)

### Patent Literature 3: JP H11-70886 A (FIGS. 1 and 5)

### Patent Literature 4: JP 2007-215279 A (FIG. 1)

### Patent Literature 5: JP 2006-166492 A (FIG. 1)

### SUMMARY OF INVENTION

### Technical Problem

In the conventional power supply device described above, however, for example, when the case (power-supplying case) is disposed on the floor of the vehicle, there are needs that the case is formed in a metal plate or a high-strength engineering plastic and an uneven portion is formed on the upper wall (upper plate portion) of the case, thereby improving rigidity such that the case is safe even when being trodden by an occupant.

Then, there were problems that: the case increases in weight when the case is formed in the metal material; the case increases in cost when the case is formed in the engineering plastic; and the case becomes thick in order to ensure an accommodation space of the wire harness or the case increases in weight or cost when the uneven portion is formed on the upper wall of the case.

In consideration of the above problems, an object of the present invention is to provide a reinforcement structure for a power-supplying case which can form a case which is reduced in cost and weight and is compacted in the thickness direction even when external force is applied to the case for accommodating a wire harness by foot treading or the like.

### Solution to Problem

In order to achieve the above object, a reinforcement structure for a power-supplying case according to one aspect of the present invention includes: a wire harness having an exterior member; and a case that accommodates the wire harness, wherein the exterior member has rigidity portions arranged between wall portions of the case in a direction orthogonal to the wall portions, the wall portions being opposite to each other, and when external force acts on the wall portions, the rigidity portions are arranged in directions in which the external force acts on the wall portions to support the wall portions together with the exterior member.

According to the above configuration, when the external force such as foot treading acts on the wall portions of the case, the rigidity portions of the exterior member act as support pillars between both the wall portions of the case which are opposite to each other and thus firmly support the wall portions, and the rigidity portions indirectly reinforce the case and thus prevent harmful deformation of the wall portions, that is, the case. That is, since one of the wall portions of the case is supported by a support portion such as a vehicle floor, when the external force acts on the other of the wall portions of the case, the other of the wall portions is bent in a direction of the external force, but the rigidity portions of the exterior member immediately contact with the other of the wall portions and thus firmly support the other of the wall portions. Since the other of the wall portions may be bent, it can be formed into a flat shape and to be light in weight using inexpensive materials.

In the reinforcement structure for the power-supplying case according to a first preferred aspect of the present invention, further to the reinforcement structure for the power-supplying case according to the one aspect of the present invention, the exterior member is a corrugated tube having a quadrangle cross section, and the rigidity portions are reinforcing ribs provided on sidewalls of the corrugated tube.

According to the above configuration, the reinforcing ribs are added to the existing corrugated tube made of a synthetic resin, and the corrugated tube can be easily and inexpensively manufactured in the same manner (extrusion molding plus vacuum forming or pressure forming) as the existing corrugated tube. The reinforcing ribs are preferably provided on both sidewalls of the corrugated tube, but can be also formed on only one sidewall. The corrugated tube is lightweight and has good bendability.

In the reinforcement structure for the power-supplying case according to a second preferred aspect of the present invention, further to the reinforcement structure for the power-supplying case according to the one aspect of the present invention, the exterior member is a caterpillar-like member, and the rigidity portions are sidewalls of the caterpillar-like member.

According to the above configuration, since the caterpillar-like member made of the synthetic resin and having the rigidity higher than that of the corrugated tube is used, the sidewalls of the caterpillar-like member become the rigidity portions and thus firmly support the external force applied to the case. The sidewalls as the rigidity portions are preferably provided on both sides of the caterpillar-like member, but can be also provided on only one side.

### Advantageous Effects of Invention

According to the one aspect of the present invention, since the external force is received by the rigidity portions of the exterior member of the wire harness even when the external force is applied to the case for accommodating the wire harness by the foot treading or the like, it is possible to indirectly reinforce the case and to form the case which is reduced in cost and weight and is compacted in the thickness direction.

According to the first preferred aspect of the present invention, since the reinforcing ribs as the rigidity portions are provided in the corrugated tube, it is possible to reduce the cost and weight of the reinforcement structure of the case.

According to the second preferred aspect of the present invention, since the sidewalls of the caterpillar-like member having the high rigidity become the rigidity portions, it is possible to firmly receive the external force applied to the case and to reliably prevent the harmful deformation of the case.

### BRIEF DESCRIPTION OF DRAWINGS

FIG. 1 is a perspective view illustrating a power supply device applied to a reinforcement structure for a power-supplying case according to an embodiment of the present invention.

FIG. 2 is a cross-sectional view taken along the line A-A in FIG. 1 illustrating the reinforcement structure for the power-supplying case according to the first embodiment of the present invention.

FIG. 3A is a perspective view illustrating an example of a corrugated tube to be used in the reinforcement structure for the power-supplying case, and FIG. 3B is a front view of FIG. 3A as viewed from an arrow B.

FIG. 4 is a cross-sectional view illustrating a reinforcement structure for a power-supplying case according to a second embodiment of the present invention.

FIG. 5A is a perspective view illustrating an example of a caterpillar-like member to be used in the reinforcement structure for the power-supplying case, and FIG. 5B is a front view of FIG. 5A as viewed from an arrow C.

FIG. 6 is a cross-sectional view illustrating a modified example of the first embodiment in FIG. 2.

FIG. 7 is a cross-sectional view illustrating a modified example of the second embodiment in FIG. 4.

### DESCRIPTION OF EMBODIMENTS

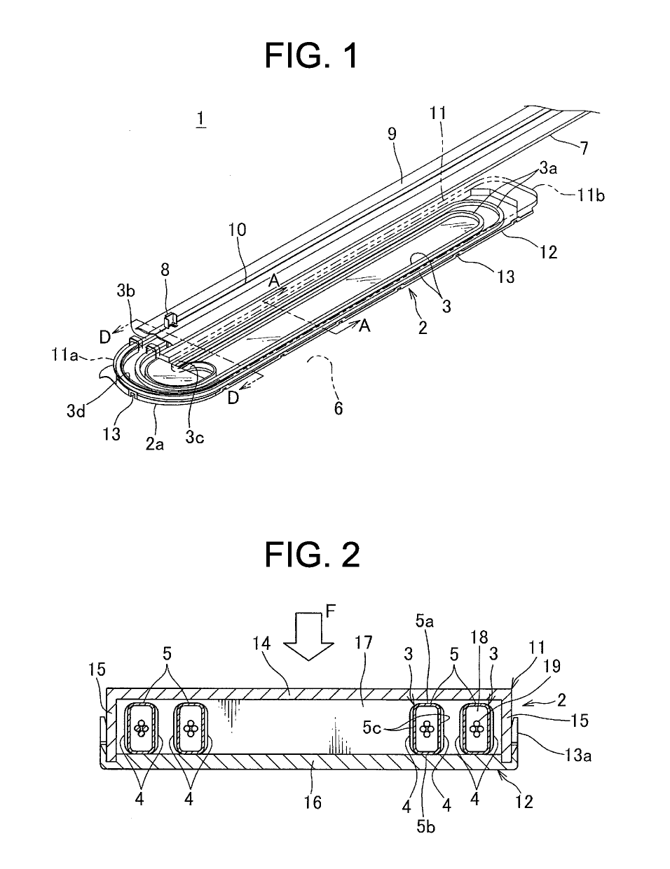

FIGS. 1 to 3A and 3B illustrate a reinforcement structure for a power-supplying case according to a first embodiment of the present invention.

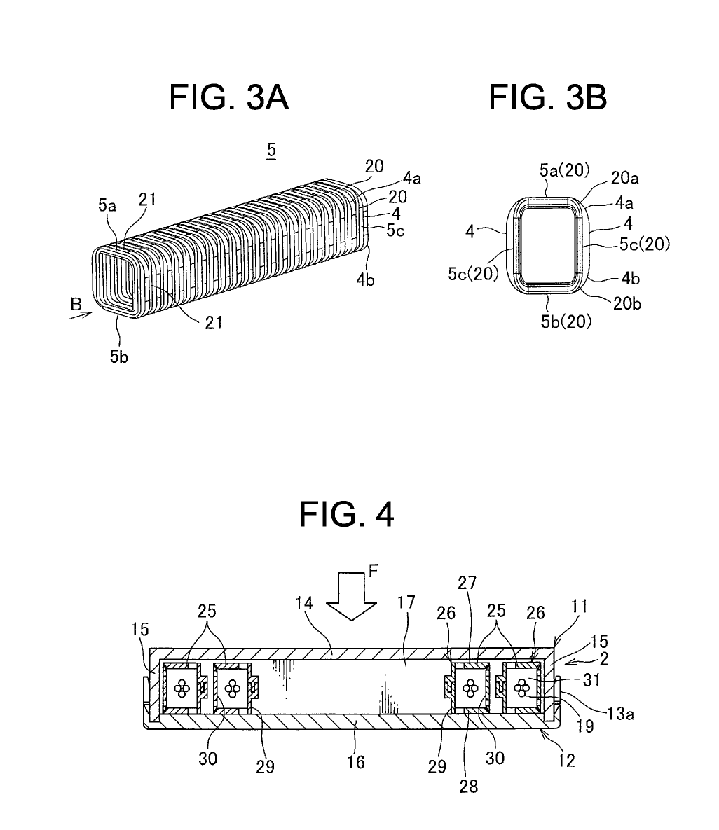

As illustrated in FIG. 1, a power supply device 1 applied to this embodiment includes a horizontally-long flat case (first case or main case) 2 that is made of a synthetic resin to constantly supply power to a sliding seat (not illustrated) for a vehicle, for example, and two wire harnesses 3 that are folded and bent into a substantially U-shape (indicating a bent portion by reference number 3a) and are arranged in the case 2, and as illustrated in FIGS. 2 and 3, each of the wire harnesses 3 includes a synthetic resin-made corrugated tube 5 as an exterior member that has a quadrangle cross section and has reinforcing ribs (rigidity portions) 4 disposed at both right and left sides.

As illustrated in FIG. 1, the case 2 is horizontally disposed on a vehicle floor 6 and is disposed such that a longitudinal direction of the case is aligned in a front/back direction of the vehicle. A second case (sub-case) 7, which is horizontally longer and is narrower in width, is disposed in parallel adjacent to the case 2, a slider 8 is provided to freely slide in the longitudinal direction of the case along a rail (not illustrated) of the second case 7, and one end side 3b of each wire harness 3 is fixed to the slider 8 and thus is led out from the slider 8 to an upper sliding seat (not illustrated). The other end side 3c of the wire harness 3 is fixed onto an opening side (not illustrated) at a front end 2a of the case 2 and then is led out from the opening to the vehicle floor 6 side (power source side).

The second case 7 is covered with a substantially plate-shaped molding 9 made of a synthetic resin, thereby being reinforced and prevented from dust, and a slit 10 is provided in the molding 9 to lead out the slider 8. The case 2 and the second case 7 are connected to each other by a semicircular portion (substituted by reference number 2a) at the front end, and each wire harness 3 is bent into a semicircular shape along the semicircular portion 2a (indicating a bent portion by reference number 3d), thereby being arranged from the case 2 to the second case 7.

The case 2 is made up of an upper case portion 11 (portion indicated by a two-dot chain line in FIG. 1) and a lower case portion 12, and the upper case portion 11 and the lower case portion 12 are locked with each other by a locking portion (lower-side locking frame portion and upper-side locking projection) 13. In this embodiment, the case 2 is a power-supplying case corresponding to a long slide.

As illustrated in FIG. 2, the upper case portion 11 of the case 2 includes a horizontal upper wall (wall portion or upper plate portion) 14, right and left vertical sidewalls 15, and front and back vertical wall portions 11a and 11b (see FIG. 1) having substantially a semicircular shape. The lower case portion 12 includes a horizontal bottom wall (wall portion) 16 and locking frame portions 13a which are vertically raised along outer surfaces of the sidewalls 15 of the upper case portion 11 from both sides of the bottom wall 16. The bottom wall 16 of the lower case portion 12 is supported on the vehicle floor 6 (FIG. 1).

A flat wire harness insertion space 17 is formed between the upper wall 14 of the upper case portion 11 and the bottom wall 16 of the lower case portion 12; the corrugated tubes 5 having a quadrangle cross section are disposed in parallel between the upper wall 14 and the bottom wall 16 of the case 2, the corrugated tube 5 being an exterior member of the wire harness 3 and including the reinforcing ribs 4 (see FIGS. 3A and 3B) extending in a vertical direction; an outer surface of a horizontal upper wall 5a of each corrugated tube 5 comes close to an inner surface of the upper wall 14 of the case 2 with a gap; an outer surface of a horizontal lower wall 5b of the corrugated tube 5 comes in slidably contact with an inner surface of the bottom wall 16 of the case 2; and right and left sidewalls 5c of the corrugated tube 5 are positioned in parallel with the right and left sidewalls 15 of the case 2 between the upper wall 14 and the bottom wall 16 of the case 2, the right and left sidewalls 5c being equipped with the reinforcing rib 4.

Then, when an occupant of the vehicle treads on the upper wall 14 of the case 2, since the upper wall 14 of the case 2 does not particularly have high rigidity (has low rigidity) in a state where the bottom wall 16 of the case 2 is supported on the vehicle floor 6 (see FIG. 1), the upper wall 14 of the case 2 is bent downward in the range of a gap between the upper wall 14 of the case 2 and the upper wall 5a of the corrugated tube 5 using the upper ends of both sidewalls 15 as supporting points; the outer surface of the upper wall 5a of each corrugated tube 5 tightly contacts the inner surface of the upper wall 14 of the case 2; and the outer surface of the lower wall 5b of each corrugated tube 5 tightly contacts the inner surface of the bottom wall (lower wall) 16 of the case 2.

Both of the right and left sidewalls 5c of each corrugated tube 5 having the reinforcing rib 4 act as a support pillar between the upper wall 14 and the bottom wall 16 of the case 2 to firmly receive treading force (external force) F and to firmly support the upper wall 14 of the case 2 without collapsing, harmful deformation or the like. The reinforcing rib 4 is formed long in a direction of the treading force F, that is, a direction in which a load is applied, and the extending direction of the reinforcing rib 4 is aligned with (in parallel with) the direction of the treading force F.

In this way, since the both sidewalls 5c of the corrugated tube 5 having the reinforcing rib 4 receive the treading force (external force) F, the case 2 can be formed at a low cost using a common inexpensive synthetic resin material (for example, PP material) without the need for rigidity of the case 2. In addition, since the upper wall 14 of the case 2 need not be reinforced in an uneven shape as in the related art, the upper wall 14 of the case 2 may be formed in a flat shape, resin molding costs are reduced, and the size of the upper wall 14 of the case 2 is prevented from increasing in a thickness direction, thereby making the case 2 to be compact in the thickness direction.

In FIG. 2, two corrugated tubes 5 are disposed in four rows at both of right and left sides of the case 2 and thus can firmly receive the treading force F. A horizontal distance between the inner corrugated tubes 5, which are disposed at a second row and a third row from the right in FIG. 2 and face each other, is preferably defined to be shorter than an average width dimension of the occupant's foot. The wire harness 3 is made up of the corrugated tube 5 and a plurality of insulation-coated electric wires 19 inserted into a rectangular inner space 18 of the corrugated tube 5.

As illustrated in FIGS. 3A and 3B, the corrugated tube 5 is formed to have a quadrangle cross section including the bellows-like horizontal upper wall 5a and lower wall 5b and the same bellows-like vertical right and left sidewalls 5c, and the reinforcing ribs 4 are integrally formed at tip (top portion) sides of bellows-like ridge portions 20 on the right and left sidewalls 5c.

The reinforcing ribs 4 are formed in a solid or hollow at the tips (top portions) of the ridge portions 20; protrude in right and left directions from the tips of the ridge portions 20, respectively, (the left-side reinforcing rib 4 protrudes in the left direction from the tip of the ridge portion 20 on the left sidewall 5c and the right-side reinforcing rib 4 protrudes in the right direction from the tip of the ridge portion 20 on the right sidewall 5c); and vertically extend in a height direction from a lower end to an upper end of the ridge portion 20. The right and left reinforcing ribs 4 are formed symmetrically to each other.

An upper end 20a and a lower end 20b of the ridge portion 20 are formed in a small-diameter curved shape (small-diameter curved portions are indicated by reference numbers 20a and 20b) on each of the sidewalls 5c and are continuous with the horizontal ridge portions 20 on the upper and lower wall portions 5a and 5b. Upper and lower portions 4a and 4b of the reinforcing rib 4 are formed in a large-diameter curved shape along the upper and lower small-diameter curved portions 20a and 20b of the ridge portion 20 on the sidewall 5c (large-diameter curved portions are indicated by reference numbers 4a and 4b). The ridge portion (20) can be also defined by including the reinforcing rib 4.

Trough portions 21 of the upper and lower wall portions 5a and 5b intersect with trough portions 21 of the right and left wall portions 5c in a curved shape, and an intersection portion (corner portion) between the upper and lower wall portions 5a and 5b and the right and left wall portions 5c is formed in a curved shape. Since the corrugated tube 5 is formed in such a manner that the plurality of ridge portions (projections) 20 and the trough portions (recessed grooves) 21 are alternately and integrally arrayed in a longitudinal direction of the tube, the trough portions 21 are located between the reinforcing ribs 4 which are formed on the right and left wall portions 5c, respectively, each of the reinforcing ribs 4 provided on the ridge portions 20 of the right and left wall portions 5c are integrally continuous with the ridge portion 20 of the upper and lower wall portions 5a and 5b on the same vertical plane, and the trough portions 21 of the right and left wall portions 5c are integrally continuous with the trough portions 21 of the upper and lower wall portions 5a and 5b on the same vertical plane.

The ridge portion 20 on an outer peripheral surface side of the corrugated tube 5 forms a trough portion on an inner peripheral surface side of the corrugated tube 5, and the trough portion 21 on the outer peripheral surface side of the corrugated tube forms a ridge portion on the inner peripheral surface side of the corrugated tube. The configuration excluding the reinforcing rib 4 is similar to that of an existing corrugated tube.

In the corrugated tube 5 of this example, the right and left wall portions 5c are formed longer to form long side portions, the upper and lower wall portions 5a and 5b are formed shorter to form short side portions, and thus bendability in the right-left direction (horizontal direction) is enhanced compared with that in the vertical direction. By the reinforcing ribs 4 extending in the vertical direction on the right and left wall portions 5c, rigidity of the tube is increased against the compressive force F (see FIG. 2) in the vertical direction. For example, the corrugated tube 5 can be also formed in a square cross section when a number of electric wires 19 (see FIG. 2) are accommodated. FIGS. 3A and 3B illustrate a part of the corrugated tube 5 in the longitudinal direction (actually, using a tube longer than the corrugated tube 5 illustrated in FIGS. 3A and 3B).

Similar to the existing corrugated tube, a rectangular cylindrical resin material (not illustrated) subjected to extrusion molding is subjected to vacuum forming or pressure forming in upper and lower molds (not illustrated), so that the corrugated tube 5 equipped with the reinforcing rib 4 can be easily formed in a bellows-like shape.

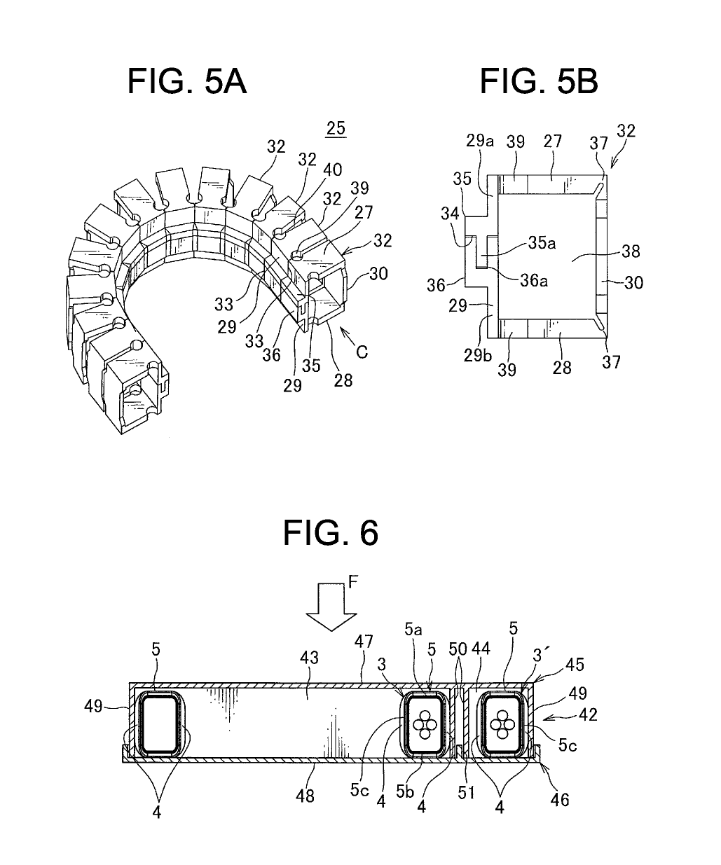

FIGS. 4, 5A and 5B illustrate a reinforcement structure for a power-supplying case according to a second embodiment of the present invention.

The reinforcement structure for the power-supplying case includes a wire harness 26 in which a caterpillar-like exterior member 25 (see FIGS. 5A and 5B) is used instead of the corrugated tube 5 in the first embodiment illustrated in FIGS. 1 to 3A and 3B, the exterior member 25 being made of a synthetic resin and having a quadrangle cross section. Since a routing structure for a case 2 or the wire harness 26 other than the caterpillar-like exterior member (hereinafter, referred to as a caterpillar-like member) 25 is similar to the configuration in FIGS. 1 and 2, the same components are denoted by the same reference numbers and a detailed description thereof will not be presented.

As illustrated in FIG. 4, two caterpillar-like members 25 are respectively folded and disposed (arranged) by two rows at both of right and left sides of a wire harness insertion space 17 between an upper wall 14 and a bottom wall 16 of the case 2. An outer surface of a horizontal upper wall 27 of each caterpillar-like member 25 comes close to an inner surface of the horizontal upper wall 14 of the case 2 with a gap; an outer surface of a horizontal lower wall 28 of each caterpillar-like member 25 comes in contact with an inner surface of the horizontal bottom wall 16 of the case 2; and right and left vertical sidewalls (rigidity portions) 29 and 30 of the caterpillar-like member 25 are positioned in parallel with right and left sidewalls 15 of the case 2 between the upper wall 14 and the bottom wall 16 of the case 2.

Each of the caterpillar-like members 25 is slidably and bendably arranged in a horizontal direction along the bottom wall 16 of the case 2 in the wire harness insertion space 17 of the case 2. The wire harness 26 is made up of the caterpillar-like member 25 and a plurality of insulation-coated electric wires 19 inserted into a rectangular inner space 31 of the caterpillar-like member 25.

As illustrated in FIGS. 5A and 5B, a plurality of piece members 32 made of a synthetic resin material are bendably coupled to one sidewall 29 to be bent inward, thereby forming the caterpillar-like member 25, the piece members 32 being formed in a quadrangle cross section (rectangular cylindrical shape) with a horizontal plate-shaped upper wall (upper plate portion) 27 and plate-shaped lower wall (lower plate portion) 28 and a vertical right and left plate-shaped sidewalls (side plate portions) 29 and 30. A rear end of one sidewall 29 of the front piece member 32 and a front end of one sidewall 29 of the back piece member 32 are coupled to each other by a thin hinge 33.

One sidewall 29 of the piece member 32 is split into upper and lower parts from the center in a height direction; locking portions 35 and 36 are provided above and below a split surface 34 of one sidewall 29, respectively; the upper locking portion 35 has a downward concave portion 35a and the lower locking portion 36 has an upward convex portion 36a; an upper half 29a and a lower half 29b of one sidewall 29 are integrally coupled and fixed to each other by engagement between the concave portion 35a with the convex portion 36a (for example, press fitting or engagement between a projection formed on the concave portion 35a and a hole formed in the convex portion 36a); and a lower surface of the concave portion 35 and an upper surface of the convex portion 36 forming the split surface 34 contact with each other.

At the top and bottom of the other sidewall 30 of the piece member 32, thin hinges 37 are formed at intersection portions between the upper and lower wall portions 27 and 28, and the upper and lower wall portions 27 and 28 are opened up and down from the split surface 34, which is formed between the upper half 29a and the lower half 29b of the one sidewall 29, using the thin hinge 37 as a supporting point and electric wires 19 (see FIG. 4) can be inserted into an inner space 38 from the opening. The thin hinge 33 for connecting the piece members 32 to each other is vertically split by the split surface 34. The upper and lower ends of the thin hinge 33 are continuous with circular holes 39 on the upper wall 27 and the lower wall 28, and the hole 39 communicates with a separation slit 40 between the piece members 32, thereby improving bendability in a horizontal direction.

In the caterpillar-like member 25 of this example, the right and left wall portions 29 and 30 are formed longer to form long side portions, the upper and lower wall portions 27 and 28 are formed shorter to form short side portions, and thus bendability in the right-left direction (horizontal direction) is enhanced compared with that in the vertical direction. By the vertical right and left wall portions 29 and 30, rigidity is increased against the compressive force (external force) F (see FIG. 4) in the vertical direction. The caterpillar-like member 25 can be also formed in a square cross section.

FIG. 5A illustrates a part of the caterpillar-like member 25 in the longitudinal direction, and the caterpillar-like member 25 to be actually used is long extended as in the wire harness 3 illustrated in FIG. 1. The case 2 illustrated in FIG. 4 is the same as the case 2 illustrated in FIG. 1.

As illustrated in FIG. 4, the upper case portion 11 of the case 2 includes the horizontal upper wall (upper plate portion) 14, the right and left vertical sidewalls 15, and the front and back vertical semicircular wall portions 11a and 11b (see FIG. 1). The lower case portion 12 includes the horizontal bottom wall (bottom plate portion) 16 and a locking frame portion 13a which are vertically raised along outer surfaces of the sidewalls 15 of the upper case portion 11 from both sides of the bottom wall 16.

A flat wire harness insertion space 17 is formed between the upper wall 14 of the upper case portion 11 and the bottom wall 16 of the lower case portion 12; the caterpillar-like member 25 of a quadrangle cross section are disposed in parallel between the upper wall 14 and the bottom wall 16 of the case 2, the caterpillar-like member 25 being an exterior member of the wire harness 26; an outer surface of a horizontal plate-shaped upper wall 27 of each caterpillar-like member 25 comes close to an inner surface of the upper wall 14 of the case 2 with a gap; and an outer surface of a horizontal plate-shaped lower wall 28 of the caterpillar-like member 25 comes in slidably contact with an inner surface of the bottom wall 16 of the case 2.

Then, when an occupant of the vehicle treads over the upper wall 14 of the case 2, since the upper wall 14 of the case 2 does not particularly have high rigidity, the upper wall 14 is bent downward, the outer surface of the upper wall 27 of each caterpillar-like member 25 tightly contacts the inner surface of the upper wall 14 of the case 2, the outer surface of the lower wall 28 of each caterpillar-like member 25 tightly contacts the inner surface of the bottom wall 16 of the case 2, and both of the right and left sidewalls 29 and 30 of each caterpillar-like member 25 acts as a support pillar between the upper wall 14 and the bottom wall 16 of the case 2 to firmly receive treading force (external force) F and to firmly support the upper wall 14 of the case 2 without collapsing, harmful deformation or the like. A hanging down direction of the right and left wall portions 29 and 30 is aligned with the direction of the treading force F, that is, a direction in which a load is applied (an upright direction of the right and left wall portions 29 and 30 is perfectly reverse to the direction of the treading force F).

In this way, since the both sidewalls 29 and 30 of the caterpillar-like member 25 receives the treading force F, the case 2 can be formed at a low cost using a common inexpensive synthetic resin material (for example, PP material) without the need for rigidity of the case 2. In addition, since the upper wall 14 of the case 2 need not be reinforced in an uneven shape as in the related art, the upper wall 14 of the case 2 may be formed in a flat shape, resin molding costs are reduced, and the size of the upper wall 14 of the case 2 is prevented from increasing in a thickness direction.

In FIG. 4, two caterpillar-like member 25 are disposed in four rows at both of right and left sides of the case and thus can firmly receive the treading force (external force) F. A horizontal distance between the inner caterpillar-like members 25, which are disposed at a second row and a third row from the right in FIG. 4, is preferably defined to be shorter than an average width dimension of the occupant's foot.

For example, after a rectangular cylindrical body is continuously formed by extrusion molding of a resin material, and a plurality of slits 40 are formed by cutting the rectangular cylindrical body with a cutter and a circular hole 39 is formed on a slit end by drilling and so on, so the caterpillar-like member 25 can be easily formed.

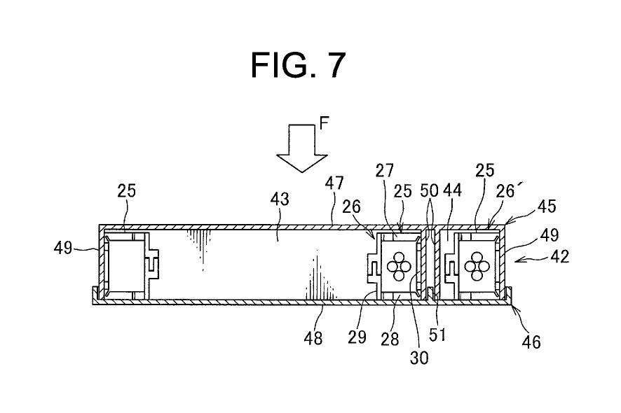

FIGS. 6 and 7 illustrate a modified example of the first embodiment and a modified example of the second embodiment, respectively.

In a reinforcement structure for a power-supplying case according to each of the modified examples, for example, the first case (main case) 2 and the second case (sub-case) 7 of the power supply device 1 illustrated in FIG. 1 are integrally formed to be connected to each other in a width (right and left) direction, thereby forming a case 42; one wire harness 3 (see FIG. 6) or 26 (see FIG. 7), not two wire harnesses, is accommodated in a wide accommodation chamber 43 of the case 42 while being folded into a substantially U-shape; one end portion 3′ (see FIG. 6) or 26′ (see FIG. 7) of one wire harness 3 or 26 is accommodated in a narrow accommodation chamber 44 adjacent to the wide accommodation chamber 43 to freely move forward and backward while being fixed to the slider 8 (see FIG. 1); and the other end portion (portion indicated by reference number 3 or 26) of the wire harness 3 or 26 is led to the outside from an opening while being fixed to the opening side of the front-side semicircular portion 2a (see FIG. 1) of the case 42. FIGS. 6 and 7 illustrate cross sections of the case 42, respectively, as viewed from the direction of the arrow D in FIG. 1.

The reinforcement structure for the power-supplying case illustrated in FIG. 6 is configured by using the corrugated tube 5 equipped with the reinforcing rib 4 illustrated in FIGS. 3A and 3B as an exterior member of the wire harness 3, and the reinforcement structure for the power-supplying case illustrated in FIG. 7 is configured by using the caterpillar-like member 25 illustrated in FIGS. 5A and 5B, as an exterior member of the wire harness 26.

Each of the power-supplying case 42 is configured by an upper case portion 45 and a lower case portion 46, the upper case portion 45 has double partition walls 50 parallel with both of right and left sidewalls 49, the double partition walls 50 being suspended from a horizontal upper wall (wall portion) 47 at one side (right side in the drawings), and the lower case portion 46 has a projecting wall 51 which is engaged between the double partition walls 50. The wide accommodation chamber 43 and the narrow accommodation chamber 44 are partitioned by the partition wall 50, a lower end of the partition wall 50 contacts a bottom wall (wall portion) 48 of the lower case portion 46, and thus the partition wall 50 also acts as a reinforcing wall against the treading (external force) of the case 42 from the above.

In the example of FIG. 6, the corrugated tube 5 equipped with the reinforcing rib 4 is disposed (arranged) at both of right and left sides inside the wide accommodation chamber 43 of the case 42 in total two rows by one row, and the corrugated tube 5 equipped with the reinforcing rib 4 is disposed (arranged) inside the narrow accommodation chamber 44 of the case 42 in one row.

A horizontal upper wall 5a of each corrugated tube 5 comes close to the upper wall 47 of the case 42 with a gap; a horizontal lower wall 5b of each corrugated tube 5 comes in slidably contact with the bottom wall 48 of the case 42; and the reinforcing ribs 4 provided on right and left wall portions 5c of each corrugated tube 5 are vertically positioned in a direction orthogonal to the upper wall 47 and the bottom wall 48 of the case 42 together with the right and left wall portions 5c. A horizontal distance between the right and left corrugated tubes 5 in the wide accommodation chamber 43 is preferably defined to be shorter than an average width dimension of the occupant's foot.

Then, when the occupant of the vehicle treads over the upper wall 47 of the case 42, since the upper wall 47 of the case 42 does not particularly have high rigidity, the upper wall 47 is bent downward, the outer surface of the upper wall 5a of each corrugated tube 5 tightly contacts the inner surface of the upper wall 47 of the case 42, the outer surface of the lower wall 5b of each corrugated tube 5 tightly contacts the inner surface of the bottom wall 48 of the case 42, and both of the right and left sidewalls 5c of each corrugated tube 5 having the reinforcing rib 4 acts as a support pillar between the upper wall 47 and the bottom wall 48 of the case 42 to firmly receive treading force (external force) F and thus to firmly support the upper wall 47 of the case 42, that is, the case 42 without collapsing, harmful deformation or the like. Since function and effect of the corrugated tube 5 equipped with the reinforcing rib 4 are similar to those in the first embodiment shown in FIGS. 1 to 3A and 3B, the detailed description thereof will not be presented.

In the example of FIG. 7, caterpillar-like members 25 are disposed (arranged) at both of right and left sides inside the wide accommodation chamber 43 of the case 42 in total two rows by one row, and the caterpillar-like member 25 is disposed (arranged) inside the narrow accommodation chamber 44 of the case 42 in one row. A horizontal upper wall 27 of each caterpillar-like member 25 comes close to the upper wall 47 of the case 42 with a gap; a horizontal lower wall 28 of each caterpillar-like member 25 comes in slidably contact with the bottom wall 48 of the case 42; and the right and left wall portions 29 and 30 of each caterpillar-like member 25 are vertically positioned in a direction orthogonal to the upper wall 47 and the bottom wall 48 of the case 42. A horizontal distance between the right and left caterpillar-like members 25 in the wide accommodation chamber 43 is preferably defined to be shorter than an average width dimension of the occupant's foot.

Then, when an occupant of the vehicle treads over the upper wall 47 of the case 42, since the upper wall 47 of the case 42 does not particularly have high rigidity, the upper wall 47 is bent downward, the outer surface of the upper wall 27 of each caterpillar-like members 25 tightly contacts the inner surface of the upper wall 47 of the case 42, the outer surface of the lower wall 28 of each caterpillar-like members 25 tightly contacts the inner surface of the bottom wall 48 of the case 42, and both of the right and left sidewalls 29 and 30 of each caterpillar-like members 25 acts as a support pillar between the upper wall 47 and the bottom wall 48 of the case 42 to firmly receive treading force (external force) F and thus to firmly support the upper wall 47 of the case 42, that is, the case 42 without collapsing, harmful deformation or the like. Since function and effect of the caterpillar-like members 25 are similar to those in the second embodiment shown in FIGS. 4 and 5, the detailed description thereof will not be presented.

Incidentally, in the first embodiment shown in FIGS. 2 and 3 described above, the reinforcing ribs 4 are formed on the right and left wall portions 5c of the corrugated tube 5 (see FIGS. 3A and 3B), but, for example, the reinforcing ribs 4 can be also formed on the right and left wall portions 5c and the upper and lower wall portions 5a and 5b. In this case, due to the upper and lower reinforcing ribs (4), the rigidity of the tube (reinforcing strength of the case 2) increases with respect to the treading force (external force) and there is no need to consider an installation direction (disposition of the reinforcing rib 4) of the corrugated tube (5) in the case 2, in the case of the corrugated tube (5) of the square cross section, in particular.

In addition, the reinforcing rib 4 can be also formed on only the left wall portion 5c or the right wall portion 5c of the corrugated tube 5. However, the rigidity is inferior to that of the corrugated tube 5 provided with the reinforcing ribs 4 on both of the right and left wall portions 5c. In all cases, the reinforcing rib 4 is preferably formed at the ridge portion 20 rather than the trough portion 21 (see FIGS. 3A and 3B) of the corrugated tube 5 in terms of ensuring the bendability of the corrugated tube 5 in the horizontal direction.

The caterpillar-like member 25 is formed by coupling the inward-bent one sidewalls 29 of the plurality of rectangular cylindrical piece members 32 (see FIGS. 5A and 5B) to each other in the second embodiment shown in FIGS. 4 and 5 described above, but it is also possible to use, for example, a caterpillar-like member (not illustrated) in which the upper and lower wall portions 27 of the plurality of rectangular cylindrical piece members 32 are bendably coupled to each other by being engaged with circular holes and pins (not illustrated) as coupling portions.

The caterpillar-like member can be also formed in the substantially U-shape cross section such that three sides of the electric wire 19 are surrounded by the upper and lower wall portions 27 and 28 and one of the right and left wall portions 30, one of the right and left wall portions 30 serving as a rigidity portion. However, the rigidity is inferior to that of the caterpillar-like member 25 having the right and left wall portions 29 and 30.

The exterior members such as the corrugated tubes 5 or caterpillar-like members 25 equipped with the reinforcing ribs 4 are disposed inside the case 2 or 42 in three rows (see FIGS. 6 and 7) or four rows (see FIGS. 2 and 4) in each of the embodiments described above, but the exterior members 5 or 25 can be also disposed inside the case 2 in two rows as in Patent Literature 1 (JP 2006-35961 A) of the related art, for example.

Although the corrugated tubes 5 or caterpillar-like members 25 equipped with the reinforcing ribs 4 are used as an exterior member of the wire harness 3 or 26 in each of the embodiments described above, the exterior member is not limited thereto and, for example, an exterior member provided in parallel with respect to the load direction of the external force F such as the foot treading and having wall portions, a pillar portion or the like acting as a support pillar against the external force F can be used.

Although the flat case 2 or 42 is transversely (horizontally) disposed in each of the embodiments described above, the exterior member 5 or 25 is configured to have the wall portions 29 and 30 as the horizontal support pillars, the wall portion 5c equipped with rib 4, the pillar portion (not illustrated) or the like so as to cope with the horizontal (right and left or transverse) external force F, for example, when the flat case 2 or 42 is longitudinally (vertically) disposed.

In addition, although the case 2 or 42 is used in the power supply device 1 as the power-supplying case in each of the embodiments described above, a rectangular cylindrical protector (not illustrated) into which the wire harness 3 or 26 is immovably inserted can be also used instead of the case 2 or 42 as the power-supplying case to protect the wire harness 3 or 26 from, for example, interference (external force) with the outside.

### INDUSTRIAL APPLICABILITY

The reinforcement structure for the power-supplying case according to the present invention can be used to form a case which is reduced in cost and weight and is compacted in the thickness direction even when the external force is applied to the case for accommodating the wire harness by the foot treading or the like.

### REFERENCE SIGNS LIST

2, 42: case
3, 26: wire harness
4: reinforcing rib (rigidity portion)
5: corrugated tube (exterior member)
5c: sidewall
14, 16, 47, 48: wall portion
25: caterpillar-like member (exterior member)
29, 30: sidewall (rigidity portion)
F: external force

1. A reinforcement structure for a power-supplying case, comprising:
a wire harness having an exterior member; and
a case that accommodates the wire harness,
wherein the exterior member has rigidity portions arranged between wall portions of the case in a direction orthogonal to the wall portions, the wall portions being opposite to each other, and
when external force acts on the wall portions, the rigidity portions are arranged in directions in which the external force acts on the wall portions to support the wall portions together with the exterior member.

2. The reinforcement structure for the power-supplying case according to claim 1, wherein
the exterior member is a corrugated tube having a quadrangle cross section, and
the rigidity portions are reinforcing ribs provided on sidewalls of the corrugated tube.

3. The reinforcement structure for the power-supplying case according to claim 1, wherein
the exterior member is a caterpillar-like member, and
the rigidity portions are sidewalls of the caterpillar-like member.
